(19) United States
(12) Patent Application Publication
(10) Pub. No.: US 2026/0202171 A1
(43) Pub. Date: Jul. 16, 2026

(54) SIGHTING OR VIEWING TELESCOPE

(71) Applicant: THALES, MEUDON (FR)

(72) Inventors: Frédéric DIAZ, SAINT-HEAND (FR); Bruno COUMERT, SAINT-HEAND (FR); Antoine BERNE, SAINT-HEAND (FR); Gabriel NARCY, SAINT-HEAND (FR); Xavier GONON, SAINT-HEAND (FR)

(21) Appl. No.: 19/138,024

(22) PCT Filed: Dec. 19, 2023
(86) PCT No.: PCT/EP2023/086626

§ 371 Date: Jun. 11, 2025

(30) Foreign Application Priority Data
Dec. 22, 2022 (FR) FR2214201

(51) Int. Cl. F41G 1/30; F41G 3/16; G02B 23/14; G02B 27/00

(52) U.S. Cl. CPC F41G 1/30; F41G 3/165; G02B 23/14; G02B 27/0081

(57) ABSTRACT

A sighting or observation scope having a sighting or observation axis x includes, in a mechanical structure: a camera, a first video micro-display displaying an image of the external landscape acquired by the camera, referred to as first object a first eyepiece associated with the first video micro-display and forming a first image of the first object at infinity a first pupil-expansion light guide arranged optically downstream of the first eyepiece and designed to extend a pupil of the first eyepiece in two directions of space and to superimpose the first image on the external landscape.

### CROSS-REFERENCE TO RELATED APPLICATIONS

This application is a National Stage of International patent application PCT/EP2023/086626, filed on Dec. 19, 2023, which claims priority to foreign French patent application No. FR 2214201, filed on Dec. 22, 2022, the disclosures of which are incorporated by reference in their entireties.

### FIELD OF THE INVENTION

The field of the invention is that of aiming scopes, in particular reflex sights, which make it possible to superimpose a reticle on the observed scene.

### BACKGROUND

To carry out their various missions with their weaponry, an infantryman has the following needs:
Daytime and nighttime shooting capability, requiring precise sighting to make best use of their weapon, ideally for effective shooting beyond 300 meters;
Rapid sighting in dynamic combat situations;
Maintaining good situational awareness so as to deal with any threat that may arise on the battlefield, both during the day and at night. This situational awareness notably involves maintaining of a wide field of vision covering the surrounding space;
Ability to “decamouflage” or perceive threats, both during the day and at night;
Discretion, which comprises, notably at night, the absence of light emission from the sighting members;
Absence of any boresighting setting operation to switch from daytime sighting to nighttime sighting and vice versa, so as to save time and ensure the reliability of the sighting;
Mobility and endurance, this requiring a piece of equipment that is as lightweight and compact as possible.

These needs are reflected in strong demands placed on the sighting members fitted on the assault rifle provided to the infantryman. In practice, these demands are only partially met, and are not met with a single piece of equipment that is both compact and lightweight.

Current solutions for carrying out sighting on an assault rifle are as follows. For daytime sighting, the weapon comprises a basic eyecup—handlebar assembly. This assembly is simple, robust and inexpensive, but offers little precision.

The weapon may also comprise, for daytime sighting, an illuminated (or “reflex”) sight, that is to say an optical assembly for superimposing a symbol or a light spot in the sighting axis onto the outside world. This illuminated sight may optionally be associated with switchable magnifying optics. It may furthermore comprise a laser pointer and a magnifying daytime scope.

For nighttime sighting, the weapon may comprise: a laser pointer, a light-intensifying aiming scope referred to as “IL”, an infrared aiming scope referred to as “IR”, a light-intensifying or infrared adaptor or clip-on positioned upstream of a daytime aiming scope, a sighting device comprising night vision goggles associated with an illuminated sight integral with the weapon.

These known solutions each have advantages and drawbacks, but none of them completely addresses the overall need identified above.

The illuminated sight solution is particularly appreciated because it offers good precision, while at the same time maintaining good perception of the overall situation, the illuminated sight transmitting the landscape without magnification.

Sighting by way of a laser pointer, which is widely used, notably at night, is highly beneficial because it allows rapid firing in dynamic combat, without the need to align the eye behind a sight, or even to shoulder the weapon in extreme situations. On the other hand, the laser pointer remains indiscreet, notably at night. Even when it is a pointer emitting in the near infrared, it is easy to detect with night vision goggles or even with some equipment using a camera sensitive in the near infrared.

Aiming scopes in general, be these daytime scopes or nighttime scopes, light-intensifying scopes or thermal infrared scopes, have the advantage of their precision, by virtue notably of their magnification. They have the drawback of having to position the eye used for sighting close to an eyepiece; moreover, the user is not able to use the other eye for overall perception. This operation takes a certain amount of time, which constitutes a loss of effectiveness in dynamic combat. In addition, the shooter momentarily cuts off from their environment and may then ignore new threats. Finally, at night, if they are equipped with night vision goggles, the fighter has to move them out of the way to be able to correctly position a free eye behind the aiming scope. Again, this represents an additional delay in the action and a break from the environment of the fighter.

Infrared or thermal aiming scopes have the same drawbacks but offer a few significant advantages: night vision, including in total darkness, improved vision in mist and smoke of the battlefield and, above all, the ability to “decamouflage” any hot target.

In an attempt to provide an appropriate response, it is possible to juxtapose multiple systems in a single piece of equipment. For example, as may be seen in FIG. 1, some pieces of sighting equipment group together an IL or IR aiming scope topped by an illuminated sight. In this case, the scope comprises a thermal camera and a visualization device. The thermal camera comprises a focusing objective 1 and a photosensitive receiver 2. The visualization device comprises a micro-display 3 and an eyepiece 4. The illuminated sight comprises a luminous symbol 5 and collimation optics 6 and superposition optics (typically a splitter plate) for superposition with the direct view 7.

These solutions result in relatively bulky pieces of equipment that offer juxtaposition of functions without, however, combining them. At a given time, the user has to choose to use either the illuminated sight or the scope and therefore never benefits from the combined advantages of the two systems. In the case of a system combining a thermal infrared scope and an illuminated sight, the user must choose between benefiting from the rapid sighting and situational awareness offered by the illuminated sight or benefiting from the decamouflaging and night vision offered by the thermal scope.

An improved solution is illustrated in FIG. 2. The same references as those in FIG. 1 designate the same elements as those described in FIG. 1. The architecture of FIG. 2 consists in combining an “advanced” reflex sight architecture with a single display 3 that is responsible for displaying everything: video stream, symbology, reticle, etc. The image of the display is returned at infinity using an eyepiece 3. Fusion with the scene is achieved using a semi-reflective plate 7. As an alternative, this element for superimposing the image formed by the eyepiece and the observed scene is a splitter cube or a prism.

The reflex sight with a display of FIG. 2, coupled with a light-intensifying or infrared camera 2, thus exhibits real added value because it provides additional assistance for highlighting a target in difficult conditions (target camouflaged, darkness, etc.) by compactly combining night and day vision.

The solution of FIG. 2, although it constitutes a significant improvement over the architecture of FIG. 1, has a drawback, however. Specifically, the element 7 for superimposing the image formed by the eyepiece and the observed scene is particularly bulky. Its overall size along the axis x, that is to say the dimension along the axis x of the projection of the element 7 onto the axis (referenced by the dimension Dₓ in FIG. 2) is typically greater than 4 cm, taking into account the elements that protect this plate.

The large overall size of this combiner element along the axis x contributes to a tunnel effect that encloses the user's vision and prevents them from having perfect knowledge of the environment surrounding them. In addition, this overall size limits the compactness of scopes from the prior art, which is a crucial parameter for a reflex sight.

### SUMMARY OF THE INVENTION

The invention aims to overcome some of the abovementioned problems of the prior art.

To this end, one subject of the invention is a sighting or observation scope having a sighting or observation axis x and comprising, in a mechanical structure:
a camera,
a first video micro-display displaying an image of the external landscape acquired by the camera, referred to as first object
a first eyepiece associated with the first video micro-display and forming a first image of the first object at infinity
a first pupil-expansion light guide comprising at least two first plane and parallel faces, the first pupil-expansion light guide being arranged optically downstream of the first eyepiece and designed to extend a pupil of the first eyepiece in two directions of space and to superimpose the first image on the external landscape, a structure of the first pupil-expansion light guide being designed such that an overall size of the first pupil-expansion light guide along the axis x is less than 2 cm.

According to one embodiment, the first pupil-expansion light guide is positioned so as to be substantially perpendicular to the axis x.

According to one embodiment, in the first pupil-expansion light guide, a dimension along the axis x of each of the first plane and parallel faces is between 2 and 5 mm.

According to one embodiment, an arrangement of the first pupil-expansion light guide, of the camera, of the first eyepiece and of the first video micro-display is designed such that an overall size of the scope along the axis x is less than 15 cm.

According to one embodiment, the first pupil-expansion light guide comprises two coupled elementary light guides so as to extend said pupil of the first eyepiece in two directions, the first elementary light guide comprising said two first plane and parallel faces and the second elementary light guide comprising two additional plane and parallel faces perpendicular to two first plane and parallel faces, and wherein:
a dimension along the axis x of each of the first plane and parallel faces is between 2 and 5 mm
a distance along the axis x separating the additional plane and parallel faces is between 2 and 5 mm.

According to one embodiment, the field of the first eyepiece is between 10° and 16° on at least one of its axes.

According to one embodiment, the scope furthermore comprises a second video micro-display displaying a second object, a second eyepiece associated with the second video micro-display and forming a second image of the second object at infinity, and a second pupil-expansion light guide comprising at least two second plane and parallel faces, the second pupil-expansion light guide being arranged optically downstream of the second eyepiece and designed to extend a pupil of the second eyepiece in two directions of space and to superimpose the second image on the first image and on the external landscape. Preferably, the second micro-display is a micro-display with low power consumption compared to the first micro-display. More preferably, the second object is a red dot or a luminous symbol.

According to one particular variant of the preceding embodiment, the scope comprises a battery supplying power to the camera, the first and second video micro-display and a processor, said processor being configured to make the scope operate in two modes comprising:
in a first mode, supplying power to the first video micro-display and not supplying power to the second video micro-display or supplying power to the first and second micro-display when a capacity of the battery is greater than a predetermined limit or when the user chooses it, for example by pressing a control member offset on said mechanical structure,
in a second mode, supplying power to the second video micro-display and not supplying power to the first video micro-display when a capacity of the battery is less than the predetermined limit, or when the processor detects malfunctioning of the first display, or when the user chooses it, for example by pressing a control member offset on said mechanical structure. Preferably, the predetermined limit corresponds to an autonomy of the battery in the first operating mode of less than 1 hour of use.

In the preceding embodiment, preferably, the first micro-display emits radiation in a first spectral range and the second micro-display emits radiation in a second spectral range disjoint from the first spectral range or the first and second micro-displays emit radiation in one and the same spectral range but having cross-polarization.

In the preceding embodiment, preferably, a structure of the first and of the second pupil-expansion light guide is designed such that an overall size of the first and second pupil-expansion light guide, respectively, along the axis x is less than 2 cm. Preferably, an arrangement of the first and of the second pupil-expansion light guide, of the camera, of the first eyepiece and of the first video micro-display, of the second eyepiece and of the second video micro-display is designed such that an overall size of the scope along the axis x is less than 16 cm.

### BRIEF DESCRIPTION OF THE DRAWINGS

Other features, details and advantages of the invention will become apparent on reading the description given with reference to the appended drawings, which are given by way of example, and in which, respectively:

FIG. 1 shows a schematic view of a sighting scope from the prior art;

FIG. 2 shows a schematic view of a sighting scope from the prior art;

FIG. 3A shows a perspective view of a sighting or observation scope according to the invention;

FIG. 3B shows a schematic view of a sighting or observation scope according to the invention;

FIG. 3C shows a cross-sectional view of one example of the first pupil-expansion light guide of the sighting or observation scope according to the invention;

FIG. 3D shows a cross-sectional view of one example of the first pupil-expansion light guide of the sighting or observation scope according to the invention;

FIG. 3F shows a cross-sectional view of one example of the first pupil-expansion light guide of the sighting or observation scope according to the invention;

FIG. 4 shows a schematic depiction of one embodiment of the scope of the invention;

FIG. 5 shows a schematic depiction of one embodiment of the scope of the invention;

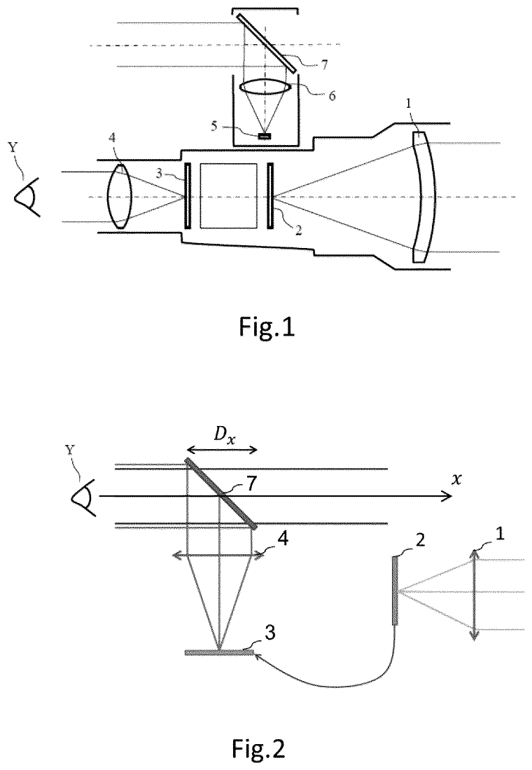

In the figures, unless indicated otherwise, the elements are not to scale and identical references designate identical elements.

### DETAILED DESCRIPTION

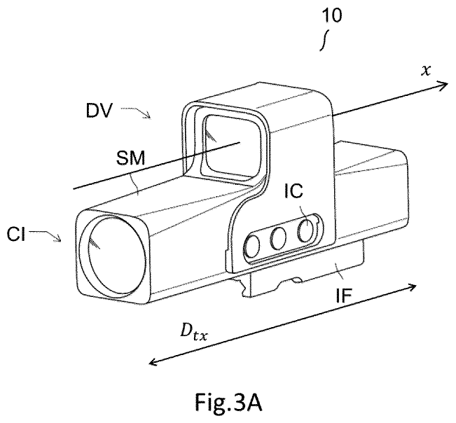

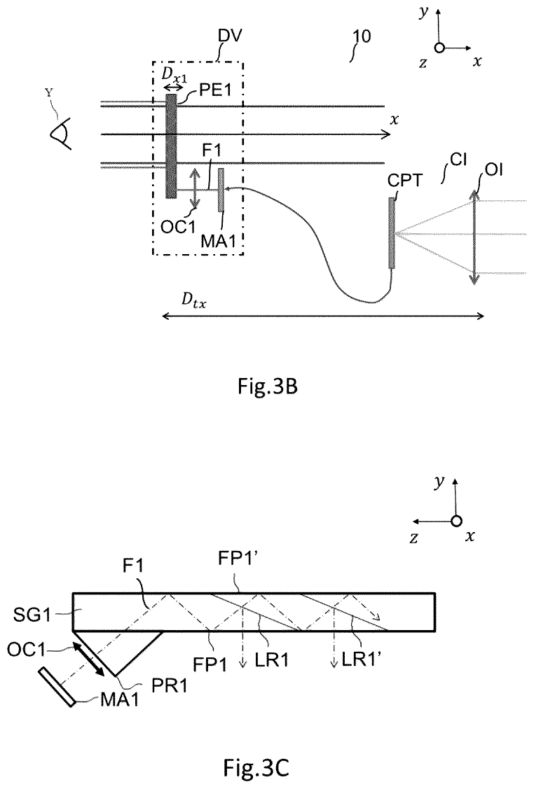

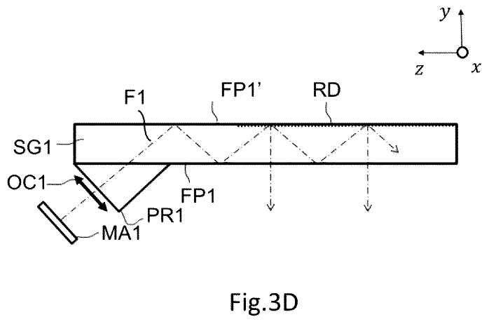

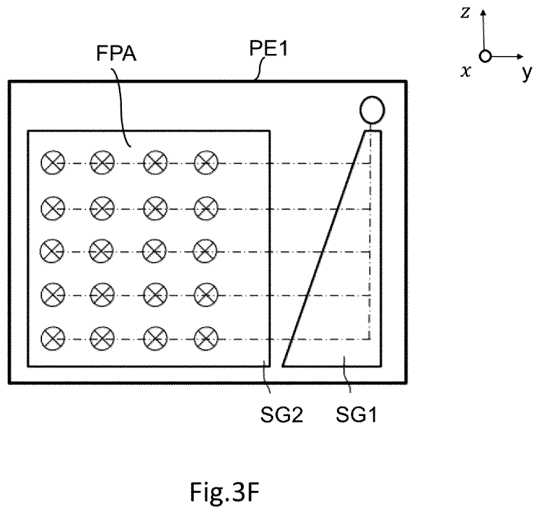

FIG. 3A shows a perspective view of a sighting or observation scope 10 according to the invention. x denotes the sighting or observation axis of the scope 10. Dₜₓ denotes the dimension of the scope along the axis x (referred to as “overall size” hereinafter).

FIG. 3B is a schematic depiction, in a plane xy, of the elements contained in the mechanical structure SM of the scope according to the invention. The scope 10 essentially comprises two main subassemblies, which are a camera CI and a visualization device DV, the structure of which is described in more detail in FIG. 3B.

The visualization device DV comprises a first micro-display MA1, a first eyepiece OC1 associated with the first display MA1 and a first pupil-expansion light guide PE1. The assembly of optical and electronic components is integrated into the waterproof mechanical structure SM, which protects them from the external environment and from impacts.

This structure SM comprises a mechanical fixing interface IF for fixing it to a weapon equipped with a standard interface. This interface is for example a “Picatinny” rail or its equivalent.

The structure SM also comprises an assembly IC of buttons and control members for carrying out notably the on/off commands for the various functions of the item of equipment, the brightness settings of the first video micro-display MA1, the electronic and mechanical boresighting settings, and the electronic settings for superimposing the various images that are generated on the external landscape. It may be positioned on one of the two lateral flanks of the scope. By way of non-limiting example, in FIG. 3A, the assembly comprises three buttons positioned on the left-hand lateral flank of the scope, other buttons being positioned on the right-hand flank of the scope.

According to the embodiment of the invention illustrated in FIG. 3B, the camera CI is a thermal camera, comprising an infrared objective Ol operating in the spectral band situated between 8 μm and 12 μm and an infrared sensor CPT sensitive in the same spectral band or between 3 and 5 μm.

As an alternative, according to another embodiment, the camera is a low-light-level camera implementing a low-noise CMOS sensor CPT, CMOS standing for Complementary Metal Oxide Semiconductor, or an EB-CMOS sensor, EB-CMOS standing for Electro-Bombarded CMOS, or else any other digital low-light-level camera.

The camera may also be an SWIR camera, SWIR standing for Short Wave Infrared, operating in the spectral band between 1 μm and 2 μm, capturing night light resulting from night glow and also offering decamouflage capabilities.

The camera CI comprises power supply, sensor control and image processing electronics and also a power supply module (none of these being shown) receiving multiple battery cells or a rechargeable battery pack so as to provide autonomy therefor, this being positioned for example at the rear of the scope, on the side of the observer's eye.

The visualization device DV comprises the first video micro-display MA1, the first eyepiece OC1 forming an image of the first video micro-display at infinity and the electronics needed to supply power to and control the first micro-display.

The first micro-display MA1 displays a sighting video reticle, possibly enriched with elevation correction elements or symbols or stadiametric graduations. It also displays an image of the external landscape acquired by the camera, referred to as first object. According to another embodiment, the first micro-display MA1 displays only the image of the external landscape acquired by the camera.

The first video micro-display MA1 is, by way of example, an OLED display, OLED standing for Organic Light Emitting Diode, an LCD display, LCD standing for Liquid Crystal Display, or an LCOS display, LCOS standing for Liquid Crystal On Silicon.

The visualization device DV furthermore comprises the first pupil-expansion light guide PE1 arranged optically downstream of the first eyepiece and designed to extend a pupil of the first eyepiece in two directions of space and to superimpose the first image on the external landscape.

A pupil-expansion light guide PE is a component that is known per se, made of a transparent material and comprising at least two plane and parallel faces FP1, FP1′. This element is commonly used in head-up displays (HUD), in which it is positioned close to the eye in order to produce a superposition between the external landscape and an image of a micro-display via an eyepiece.

FIG. 3C illustrates a cross-sectional view of one example of an elementary light guide SG1 of the waveguide PE of the invention allowing the pupil of the first eyepiece OC1 to be extended in the direction z.

The elementary light guide SG1 comprises at least two plane and parallel faces FP1, FP1′. The light beams F1 coming from the first micro-display MA1 and collimated by the first eyepiece OC1 penetrate for example into the elementary light guide via one of its lateral faces FP1. Entry into the guide may take place, as in the case shown, using a prism PR1, but also with a grating, which is then called an entrance grating.

The beams F1 propagate through the elementary light guide SG1 through total reflections from the parallel faces FP1, FP1′ of the guide SG1, as illustrated in FIG. 3C.

In order for the observer Y to be able to perceive the image of the first micro-display, it is necessary to make it leave the guide SG1. There are numerous optical solutions for achieving this. By way of first example, the guide SG1 of FIG. 3C comprises two parallel semi-reflective plates LR1, LR1′ arranged at an angle with respect to the parallel faces FP1, FP1′ so as to extract some of the collimated beams F1.

According to a second example, instead of the parallel semi-reflective plates LR1, LR1′, the guide SG1 comprises an array of microstructures or micro-prisms that carries out the same light extraction function.

According to a third example illustrated in FIG. 3D, instead of the parallel semi-reflective plates LR1, LR1′, the guide SG1 comprises a diffraction grating RD that diffracts some of the light toward the outside of the guide SG1 in the desired direction. This diffraction grating RD is situated on one of the two faces FP1, FP1′ of the guide SG1 or the actual inside of the guide SG1.

In order to extend the pupil of the first eyepiece OC1 in two directions of space, the waveguide PE1 of the invention comprises for example two coupled elementary light guides SG1, SG2 as illustrated in FIG. 3F. The elementary light guide SG2 comprises two plane and parallel faces (only one face FPA is visible in FIG. 3F) that are substantially perpendicular to the faces FP1, FP1′ of the guide SG1. The waveguide PE is thus designed to extend the pupil in two dimensions.

Throughout the rest of the document, “extraction means” is the name given to the element of the elementary guides SG1, SG2 designed to extract the light reflected through total internal reflection from the parallel faces of the elementary guides SG1, SG2.

Preferably, as illustrated in FIG. 3F, these two directions are the directions y and z, are normal to one another and are normal to the sighting axis x. This allows the first image to be superimposed more conformally on the external landscape. In the example of FIG. 3F, the circled crosses indicate that the light propagates in a plane perpendicular to that of the page, in a direction parallel to the axis x.

By virtue of the use of a pupil-expansion light guide PE1 carrying out a function of superposing the first image and the external landscape, the scope 10 of the invention has an overall size Dₜₓ that is reduced compared to scopes from the prior art.

Specifically, the waveguide PE1 of the invention has a structure and an arrangement such that its overall size Dₓ along the sighting axis x is much smaller than that of the optical combining devices that are commonly used in scopes from the prior art. This overall size Dₓ is made possible primarily by appropriately selecting the dimensions of the plane and parallel faces of the waveguide PE1 from which the beams F1 are reflected in order to propagate through the light guide (for example the faces FP1, FP1′ of the guide SG1 of FIG. 3C) and/or the distances separating these faces. As mentioned above, the optical combining devices used in scopes from the prior art have an overall size along the axis x of typically greater than 4 cm. Conversely, the waveguide PE1 of the invention has a structure and an arrangement such that its overall size Dx along the sighting axis x is less than 2 cm, and preferably less than 1 cm. Specifically, the inventors have identified, through numerous experiments, that the tunnel effect caused by an optical combining element becomes significantly less bothersome when the latter has an overall size along the sighting axis of less than 2 cm, taking into account the various protective elements of the light guide. Furthermore, the visualization device DV is the weakest part of the scope, and it is necessary to protect it via a frame (for example the metal structure SM of FIG. 3A). By virtue of a thin waveguide PE1, the protective frame may also be thinner, thereby allowing a reduction in the overall mass of the scope of the invention. The overall size Dₓ is measured here taking into account the protective elements of the waveguide PE1.

By virtue of its function of superposing the first image and the external landscape, the waveguide PE1 is at least partially designed with elements that are transparent in the visible (typically the plane and parallel faces). “Transparent” is understood here to mean that the waveguide PE has transmission in the visible greater than 90%.

In one preferred implementation of the invention, the waveguide PE has a vertical dimension (in the direction y) of 24 mm and a horizontal dimension (in the direction z) of 30 mm. The field of view is between 10° and 16° for the vertical and horizontal axis. It is preferably 14° along the horizontal axis and 10° along the vertical axis. Furthermore, the transmission coefficient for the micro-display MA1 is 3% and the transmission coefficient for the external landscape is 90%.

Preferably, the first micro-display emits radiation in a first spectral range having a spectral extent less than or equal to 20 nm. It is then easier to design and manufacture a first guide PE1 having high transmission in the visible for the ray coming from the external landscape and high transmission for the beams F1 coming from the first micro-display.

Preferably, the first pupil-expansion light guide is positioned so as to be substantially perpendicular to the axis x so as to minimize the overall size of the scope.

In the embodiment of FIGS. 3C to 3F, this overall size Dx may for example be obtained by selecting:
a dimension along the axis x of between 2 and 5 mm for the faces FP1, FP1′ of the elementary guide SG1, and
a distance of between 2 and 5 mm separating the parallel faces of the elementary guide SG2 extending in the plane zy.

Preferably, in embodiment MP, an arrangement of the first pupil-expansion light guide PE1, of the camera CI, of the first eyepiece and of the first video micro-display MA1 is designed such that the overall size Dₜₓ of the scope along the axis x is less than 15 cm. The scope 10 is thus notably more compact than scopes from the prior art.

Preferably, the field of view of the first eyepiece is between 10° and 16° on at least one of its axes. Preferably, the field of view at the exit of the first guide PE1 is identical to that of the first eyepiece.

Preferably, the one or more extraction means of the guide PE are designed such that the light, at the exit of the guide PE, has a substantially even luminance in a plane perpendicular to the axis x. “Substantially even luminance” is understood here to mean a luminance equal to ±25%. This thus ensures uniformity of the luminance perceived by the user for any position of the eye and for any viewing angle.

A person skilled in the art is aware of several ways to obtain this even luminance. For example, in the embodiment of FIG. 3C in which the extraction means is formed by the semi-reflective plates LR1, LR1′, this even luminance may be obtained by choosing a higher reflection coefficient for the plate LR1′ than for the plate LR1.

As an alternative, in the embodiment of FIG. 3D in which the extraction means is a diffraction grating RD, the diffraction efficiency may increase in the direction z.

According to the embodiment illustrated in FIGS. 3B and 3C, the scope of the invention is a reflex sight and the optical chain consisting of the camera, the first micro-display and the eyepiece has a unit magnification, the image of the first micro-display being in conformity with that of the external landscape. The waveguide PE then ensures perfect superposition of the image of the micro-display on the external landscape.

As an alternative, according to another embodiment, the scope has a magnification greater than one. For this purpose, the scope 1 comprises for example an afocal optical system arranged optically downstream of the waveguide PE so as to form a superimposed image of the first micro-display and of the observed scene with a magnification greater than 1.

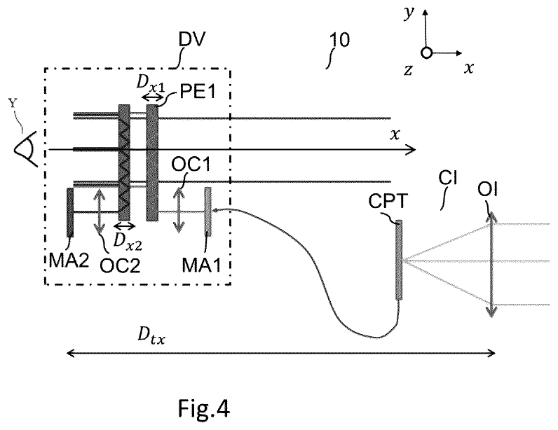

FIG. 4 illustrates one embodiment of the scope of the invention in which the scope comprises a second video micro-display MA2. The image displayed by the second video micro-display MA2 is called second object.

The scope 10 furthermore comprises a second eyepiece OC2 associated with the second video micro-display and forming a second image of the second object at infinity and a second pupil-expansion light guide PE2. The second light guide PE2 comprises at least two second plane and parallel faces and plays a role similar to the role of the first light guide PE1. Therefore, the second pupil-expansion light guide PE2 is arranged optically downstream of the second eyepiece and is designed to extend a pupil of the second eyepiece OC2 in two directions of space and to superimpose the second image on the first image and on the external landscape.

The first and second video micro-display MA1, MA2 are, by way of example, OLED displays, OLED standing for Organic Light Emitting Diode, LCD displays, LCD standing for Liquid Crystal Display, or LCOS displays, LCOS standing for Liquid Crystal On Silicon.

The use of two displays makes it possible to make the scope of the invention more versatile by combining multiple functions (for example, one display relaying an IR image and another relaying a thermal image). In addition, this makes the scope of the invention more robust, for example by allowing switching to the second micro-display when the first micro-display malfunctions.

In addition, by selecting one micro-display with low power consumption compared to the other micro-display, the scope of the invention allows operation in a “degraded” mode by displaying a red dot/customizable reticle with an autonomy of a few hundred hours. The user is thus able to extend their mission when the capacity of the battery supplying power to the sight drops below a critical threshold.

More precisely, according to a first embodiment M1, the second micro-display is a micro-display with low power consumption compared to the first micro-display. “Low power consumption” is understood here to mean that the second micro-display has a power consumption of between 0.5 mW and 10 mW, whereas the first micro-display has a power consumption of greater than or equal to 50 mW.

Preferably, in embodiment M1, the second micro-display displays a red dot or a luminous symbol. Since the luminous object is fixed over time, the power consumption of the second micro-display is greatly reduced.

Preferably, in embodiment M1, the second micro-display has a refresh rate less than or equal to 2 Hz in order to reduce its power consumption. In addition, the refresh rate of the first micro-display is high in order to be compatible with a video stream. Therefore, the first micro-display has a refresh rate greater than or equal to 20 Hz.

By way of non-limiting example, in embodiment M1, the first video micro-display MA1 is an MDP07 OLED from Microoled. It allows the reflex sight to operate nominally by projecting any available information: reticle, symbology, image, video stream, etc.

By way of non-limiting example, in embodiment M1, the second video micro-display MA2 is an MDP05 OLED from Microoled.

According to one variant (denoted V1) of embodiment M1, the first micro-display MA1 displays only the image of the external landscape acquired by the camera, whereas the second micro-display MA2 displays a sighting reticle.

In comparison with a scope from the prior art, the use of two light guides PE1, PE2 makes it possible to reduce the overall size Dₜₓ of the scope of the invention.

Preferably, a structure of the first and of the second pupil-expansion light guide PE1, PE2 is designed such that an overall size Dₓ₁, Dₓ₂, of the first and second light guide PE1, PE2, respectively, along the axis x is less than 2 cm.

More preferably, an arrangement of the first and of the second pupil-expansion light guide PE1, PE2, of the camera CI, of the first eyepiece and of the first video micro-display MA1, of the second eyepiece and of the second video micro-display MA2 is designed such that an overall size Dₜₓ of the scope along the axis x is less than 16 cm.

In order to facilitate the design and transmission of the guides PE1 and PE2, the first micro-display emits radiation in a first spectral range and the second micro-display emits radiation in a second spectral range disjoint from the first spectral range. Advantageously, the first and second spectral range have a spectral extent less than or equal to 20 nm, achieved for example by adding spectral filters positioned in front of the micro-displays. This makes it possible to further simplify the design of the guides PE1 and PE2.

As an alternative, in order to simplify the design of the guides PE1 and PE2, the two micro-displays MA1, MA2 emit radiation R1, R2 in one and the same spectral range but with cross-polarization so that each guide PE1, PE2 acts only on the radiation coming from the micro-display MA1 and from the micro-display MA2, respectively.

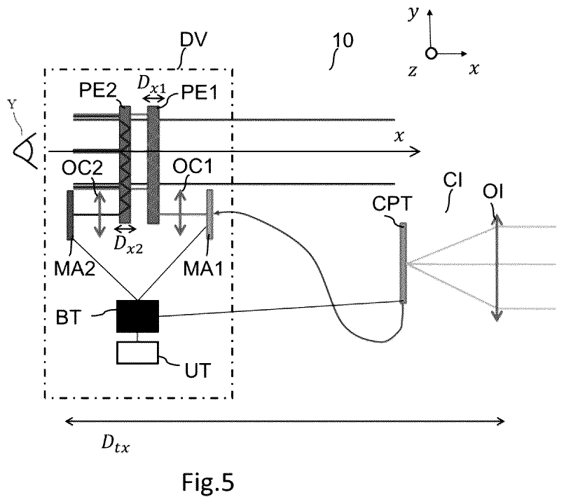

FIG. 5 illustrates one preferred embodiment of embodiment M1, in which the scope 10 comprises a battery BT supplying power to the camera CI, the first and second video micro-display MA1, MA2 and a processor UT controlling the operation of the battery in a first and second mode.

In the first mode, the battery supplies power to the first video micro-display and does not supply power to the second video micro-display when a capacity of the battery is greater than a predetermined limit. As an alternative, according to variant V1, the battery supplies power to the two micro-displays MA1, MA2 in the first operating mode.

In the second operating mode, the battery supplies power to the second video micro-display and does not supply power to the first video micro-display when a capacity of the battery is less than the predetermined limit. The processor UT thus enables the battery to operate in a second “degraded” mode in order to save the autonomy of the scope 10 when the capacity of the battery falls below a limit defined by the user or the manufacturer. In this degraded mode, only a simple reticle is then able to be used by the user. As an alternative, the reticle is displayed in combination with at least one element displaying information on the sight, for example a low battery indicator and/or elements for carrying out various settings such as electronic boresighting setting, brightness adjustment, etc.

Preferably, the predetermined limit of the battery corresponds to an autonomy of the battery in the first operating mode of less than 1 hour of use. By way of non-limiting example, this limit is equal to 1000 mAh±50%. This limit makes it possible to continue to obtain the display of a red dot with an autonomy of a few hundred hours via the switch to the second operating mode of the battery.

In a first variant of the embodiment of FIG. 3C, the processor is furthermore configured such that the battery operates in the second mode (supplying power to the second video micro-display and not to the first video micro-display) when the processor detects malfunctioning of the first display or of the camera CI. By way of example, the malfunction may be a power supply problem. This variant makes it possible to obtain a more robust scope 10.

In a second variant of the embodiment of FIG. 3C, which may be combined with the first variant, the processor is furthermore configured such that the battery operates in the second mode or in the first mode depending on the selection made by the user, for example by pressing one of the control members IC offset on the mechanical structure SM. This variant makes it possible to obtain a more versatile scope by selecting an enriched mode (first mode) or degraded mode (second mode) depending on the mission and the evolution thereof.

In all of its embodiments, the sighting scope according to the invention may comprise additional modular optical systems for modifying the perception of the external landscape. It is thus possible to position, downstream of the one or more waveguides PE1, PE2, magnifying afocal optics with a magnification of 3, for example. In the same way, it is possible to position, upstream of the one or more light guides PE1, PE2, a light-intensifying optical module that is invariant in terms of magnification and axis deviation. The user thus perceives both an intensified image and a thermal image of the external landscape.

1. A sighting or observation scope having a sighting or observation axis x and comprising, in a mechanical structure (SM):
a camera (CI),
a first video micro-display (MA1) displaying an image of the external landscape acquired by the camera, referred to as first object
a first eyepiece (OC1) associated with the first video micro-display and forming a first image of the first object at infinity
a first pupil-expansion light guide (PE1) comprising at least two first plane and parallel faces (FP1, FP1′), the first pupil-expansion light guide (PE1) being arranged optically downstream of the first eyepiece and designed to extend a pupil of the first eyepiece in two directions of space and to superimpose the first image on the external landscape, a structure of the first pupil-expansion light guide (PE1) being designed such that an overall size (Dₓ₁) of the first pupil-expansion light guide (PE1) along the axis x is less than 2 cm.

2. The scope as claimed in claim 1, wherein the first pupil-expansion light guide is positioned so as to be substantially perpendicular to the axis x.

3. The scope as claimed in claim 1, wherein, in the first pupil-expansion light guide (PE1), a dimension along the axis x of each of the first plane and parallel faces is between 2 and 5 mm.

4. The scope as claimed in claim 3, wherein an arrangement of the first pupil-expansion light guide (PE1), of the camera (CI), of the first eyepiece and of the first video micro-display (MA1) is designed such that an overall size (Dₜₓ) of the scope along the axis x is less than 15 cm.

5. The scope as claimed in claim 1, wherein the first pupil-expansion light guide (PE1) comprises two coupled elementary light guides (SG1, SG2) so as to extend said pupil of the first eyepiece in two directions, the first elementary light guide (SG1) comprising said two first plane and parallel faces (FP1, FP1′) and the second elementary light guide (SG2) comprising two additional plane and parallel faces (FPA) perpendicular to the two first plane and parallel faces (FP1, FP1′), and wherein:
a dimension along the axis x of each of the first plane and parallel faces is between 2 and 5 mm
a distance along the axis x separating the additional plane and parallel faces is between 2 and 5 mm.

6. The scope as claimed in claim 1, wherein the field of the first eyepiece is between 10° and 16° on at least one of its axes.

7. The scope as claimed in claim 1, furthermore comprising a second video micro-display (MA2) displaying a second object, a second eyepiece (OC2) associated with the second video micro-display and forming a second image of the second object at infinity, and a second pupil-expansion light guide (PE2) comprising at least two second plane and parallel faces, the second pupil-expansion light guide (PE2) being arranged optically downstream of the second eyepiece and designed to extend a pupil of the second eyepiece in two directions of space and to superimpose the second image on the first image and on the external landscape.

8. The scope as claimed in claim 7, wherein the second micro-display is a micro-display with low power consumption compared to the first micro-display.

9. The scope as claimed in claim 8, wherein the second object is a red dot or a luminous symbol.

10. The scope as claimed in claim 7, comprising a battery supplying power to the camera, the first and second video micro-display and a processor, said processor being configured to make the scope operate in two modes comprising:
in a first mode, supplying power to the first video micro-display and not supplying power to the second video micro-display or supplying power to the first and second micro-display (MA1, MA2) when a capacity of the battery is greater than a predetermined limit or when the user chooses it, for example by pressing a control member (IC) offset on said mechanical structure,
in a second mode, supplying power to the second video micro-display and not supplying power to the first video micro-display when a capacity of the battery is less than the predetermined limit, or when the processor detects malfunctioning of the first display, or when the user chooses it, for example by pressing a control member (IC) offset on said mechanical structure.

11. The scope as claimed in claim 10, wherein the predetermined limit corresponds to an autonomy of the battery in the first operating mode of less than 1 hour of use.

12. The scope as claimed in claim 7, wherein the first micro-display emits radiation in a first spectral range and the second micro-display emits radiation in a second spectral range disjoint from the first spectral range or the first and second micro-displays (MA1, MA2) emit radiation in one and the same spectral range but having cross-polarization.

13. The scope as claimed in claim 7, wherein a structure of the first and of the second pupil-expansion light guide (PE1, PE2) is designed such that an overall size (D_{x1,}D_{x2,}) of the first and second pupil-expansion light guide (PE1, PE2), respectively, along the axis x is less than 2 cm.

14. The scope as claimed in claim 13, wherein an arrangement of the first and of the second pupil-expansion light guide (PE1, PE2), of the camera (CI), of the first eyepiece and of the first video micro-display (MA1), of the second eyepiece and of the second video micro-display (MA2) is designed such that an overall size (Dₜₓ) of the scope along the axis x is less than 16 cm.
